(19) United States
(12) Patent Application Publication
(10) Pub. No.: US 2018/0345510 A1
(43) Pub. Date: Dec. 6, 2018

(54) TRIMMER WITH HAIR COLLECTOR

(71) Applicant: BaByliss Faco sprl, Wandre (BE)

(72) Inventors: Pierre JULEMONT, Soumagne (BE); Olivier SMAL, Magnée (BE)

(73) Assignee: BaByliss Faco sprl, Wandre (BE)

(21) Appl. No.: 15/776,328

(22) PCT Filed: Nov. 4, 2016
(86) PCT No.: PCT/EP2016/076733

§ 371 Date: May 15, 2018

(30) Foreign Application Priority Data
Nov. 18, 2015 (EP) 15195159.7

(51) Int. Cl. B26B 19/38; B26B 19/20

(52) U.S. Cl. CPC B26B 19/3813; B26B 19/20; B26B 19/3853

(57) ABSTRACT

The present invention relates to a suction-free clipper comprising a handle (2) with a built-in hair collector (3) located below the cutting system (6) which, during use, collects at least some of the cut hair.

### SUBJECT MATTER OF THE INVENTION

The present invention relates to a trimmer, in particular a suction-free beard trimmer, comprising a collector for cut hairs located below the cutting mechanism into which, during trimming, the hairs fall essentially by gravity.

### BACKGROUND OF THE INVENTION

Trimmers for hair or beard hairs are well known by those skilled in the art. To get rid of cut hairs, there are currently two main options. Either the hairs are quite simply allowed to fall in the location where one is shaving, or an effort is made to collect them using a suction system.

Suction systems may be external and connected to the trimmer by a hose or be built directly into the trimmer. In the latter case, a turbine built into the trimmer generally produces suction close to the cutting head and deviates the cut hairs toward a collection reservoir allowing the suction air to pass, which then makes it possible to collect part of the cut hairs.

Documents DE2747896A1; U.S. Pat. No. 7,076,878; US 20060162516A1; US 20060230619; US 20090277012A1; U.S. Pat. No. 6,739,05362, etc. all belong to this family of trimmers.

The main drawback of this approach is that, for a suction system built into this type of trimmer, the volume, which must accommodate a particular arrangement configuration of a turbine and a reservoir, is generally much more significant than that of an ordinary trimmer, which is not equipped with such a hair suction installation. For trimmers that comprise a suction system outside the apparatus that is generally connected to the latter by a flexible hose, the size of the trimmer is that of an ordinary trimmer, but the presence of the hose that connects it to the suction source makes it inconvenient to handle, which is why this type of arrangement is rarely used.

To date, to the best of our knowledge, no intermediate solution exists between the trimmer equipped with suction and a trimmer with no hair collection means. There is, however, a need for an apparatus, which, without having the hair collection possibilities of a suction trimmer, nevertheless collects part of the hairs when trimming a relatively short beard.

Document WO2015/123412 A1 discloses a trimmer comprising a handle and a hair collector connected to a suction source. The hair collector comprises a slit maximizing the movement speed of the air created by the suction source in the immediate vicinity of the slit. This configuration is inappropriate for working without suction, since the suction slit would become clogged quickly. Like all trimmers working with suction, the presence of a hair collection reservoir and a turbine requires a size suitable for comprising these elements, which causes significant oversizing.

### AIMS OF THE INVENTION

The present invention aims to overcome this drawback by disclosing a suction-free trimmer with a hair collector that collects the hairs essentially by gravity and trapping using a comb with a specific shape, the hair collector being located close to the cutting system.

### BRIEF DESCRIPTION OF THE FIGURES

FIG. 1 shows three-dimensional views of the trimmer according to the invention. The hair collector is almost completely covered by the comb.

FIG. 2 shows a three-dimensional view of the trimmer according to the invention with the comb in the withdrawn position to access the hair collector.

FIG. 3 shows a front view of the cutting system of the trimmer according to the invention. One can see the specific geometry of the inverted V-shaped combs making it possible to form a trap for the hairs once the latter have passed through the comb and been cut.

FIG. 4 shows a three-dimensional view of a first embodiment of the invention where the hair collector assumes the form of a reservoir that is fastened against the handle of the trimmer. The space provided for fastening of the reservoir has essentially the same shape and nearly the same depth as the latter. The comb is completely removable to facilitate cleaning of the assembly.

FIG. 5 shows a three-dimensional view of a second embodiment of the invention where the hair collector assumes the form of a cover that is fastened against the handle of the trimmer and where the surface of the handle below the cover serves as a reservoir bottom for the cut hairs. The space provided for fastening the cover determines the depth of the reservoir available for collecting hairs. In this configuration, the comb is also completely removable.

FIG. 6 shows a sectional view of the first embodiment of the invention, where the hair collector in reservoir form is fastened against the handle in the location provided to that end.

FIG. 7 shows a sectional view of the second embodiment of the invention where the hair collector in cover form is fastened against the handle in the location provided to that end.

FIG. 8 shows a detail view of the passage of the hairs through the cutting system. The trimmer moves here from bottom to top.

FIG. 9 shows, in detail, how the hairs, once cut, are trapped by the combs in an inverted V shape.

FIG. 10 shows the hair collection mechanism when the trimmer is raised along the cheek. The movement is done from bottom to top.

FIG. 11 shows the hair collection mechanism when the beard is trimmed below the chin. Here also, the movement is done from bottom to top.

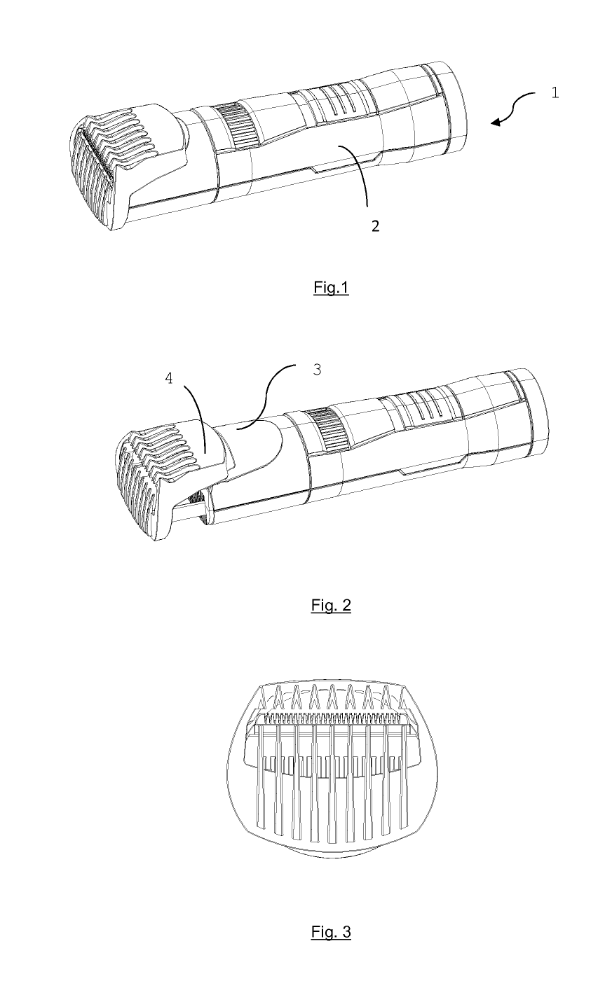

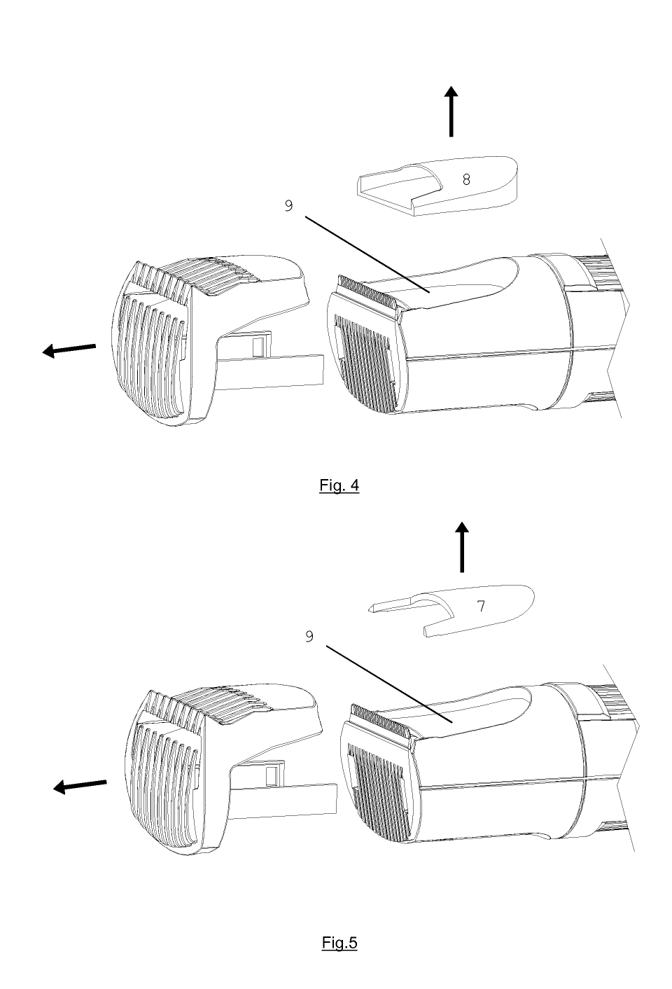

### LEGEND

(1) Trimmer
(2) Handle of the trimmer
(3) Hair collector
(4) Comb
(5) Teeth of the comb
(6) Cutting system
(7) Hair collector in cover form
(8) Hair collector in reservoir form
(9) Hollow space on the handle allowing fastening of the hair collector
(10) Hair trapped by the inverted V-shaped comb

### SUMMARY OF THE INVENTION

The present invention discloses a suction-free trimmer comprising a handle with a built-in hair collector located below the cutting system which, in use, collects at least part of the cut hairs.

Particular embodiments of the invention comprise at least one of the following features:

the trimmer is a beard trimmer;

the hair collector is made in the form of a cover or in the form of a reservoir fastened on the handle in a hollow space having substantially the same shape as said cover or reservoir;

the hair collector is removable;

the trimmer further comprises a comb, the shape of the teeth of which is configured so as to trap the hairs once they have passed through the comb by gradually reducing the gap between the teeth in the penetration direction;

the teeth have an inverted V shape;

the comb covers at least partly the hair collector;

the comb is removable to free the hair collector;

the parts in contact with the hairs, in particular the comb, are made from a conductive material with a conductivity below 10⁶ Ohm, preferably below 10³ Ohm according to standard EN 13463-1.

### DETAILED DESCRIPTION OF THE INVENTION

The present invention relates to a suction-free trimmer comprising a hair collector suitable for collecting a large proportion of hairs when trimming a beard or head, for example.

As we explained in the description of the prior art, the trimmers of the state of the art comprise hair collection reservoirs supplied with hairs aspirated by a suction system. When the suction system is built into the trimmer, they are fairly bulky, since they must be equipped with a turbine and provide an easy flow of air through the entire suction system. When the suction system is outside the trimmer, the hose connecting it to the suction source greatly hinders the manipulation of the trimmer.

The trimmer 1 according to the present invention does not have any of these drawbacks and has a collection reservoir that we also call the hair collector 3, which collects the majority of the hairs, which, once cut, pass through an inverted V-shaped comb making it possible to trap the hairs and cause them to fall into this hair collector 3.

The trimmer according to the invention is therefore not larger, for the most part, than an ordinary trimmer without a hair collector 3.

The hair collector 3 may be formed by a reservoir 8 or a simple cover 7 in the form of a cover that is fastened against a hollow space 9 provided to that end on the handle 2. These embodiments are respectively shown in FIGS. 4 and 5. The hollow part 9 provided for receiving the hair collector has substantially the same shape as the cover 7 or the reservoir 8, such that the hair collector 3 is perfectly integrated into the handle 2 of the trimmer and can thus be covered by the comb 4 during use.

Once the beard trimming is complete, the comb 2 may be withdrawn (see FIGS. 4 and 5) to free the hair collector, which can then be emptied and cleaned. The comb 4 is completely removable.

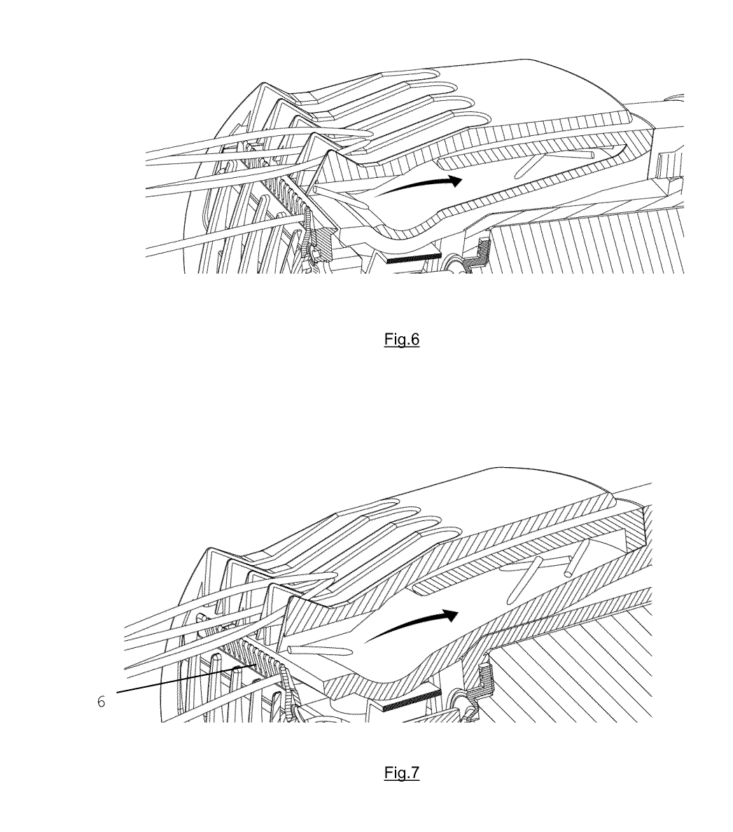

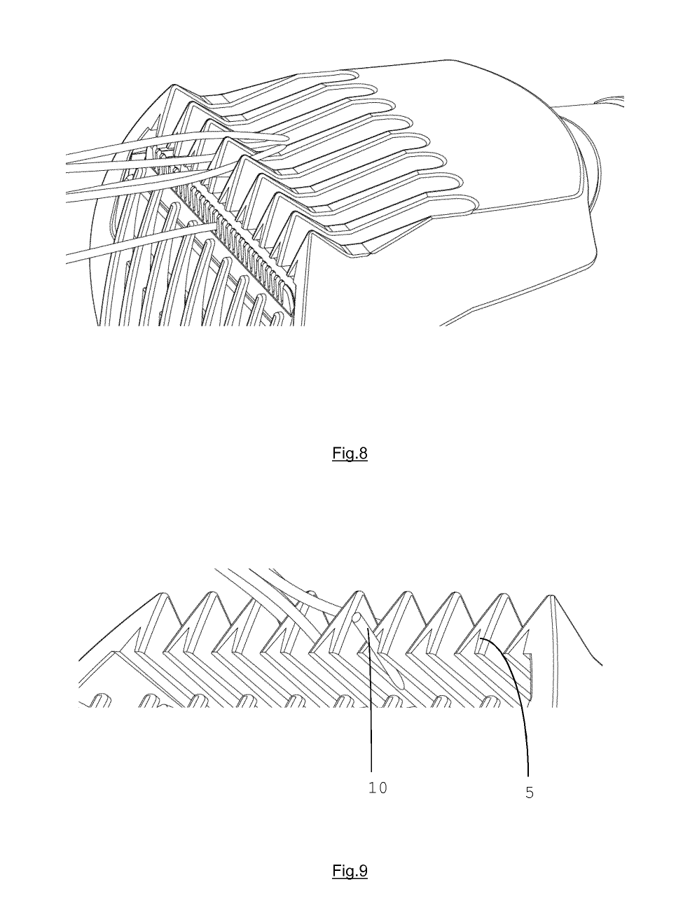

The inverted V-shaped comb 4 is located just above the cutting system of the trimmer and makes it possible to trap the hairs once they have been cut and the latter then travel toward the hair collector (see FIGS. 6 to 9).

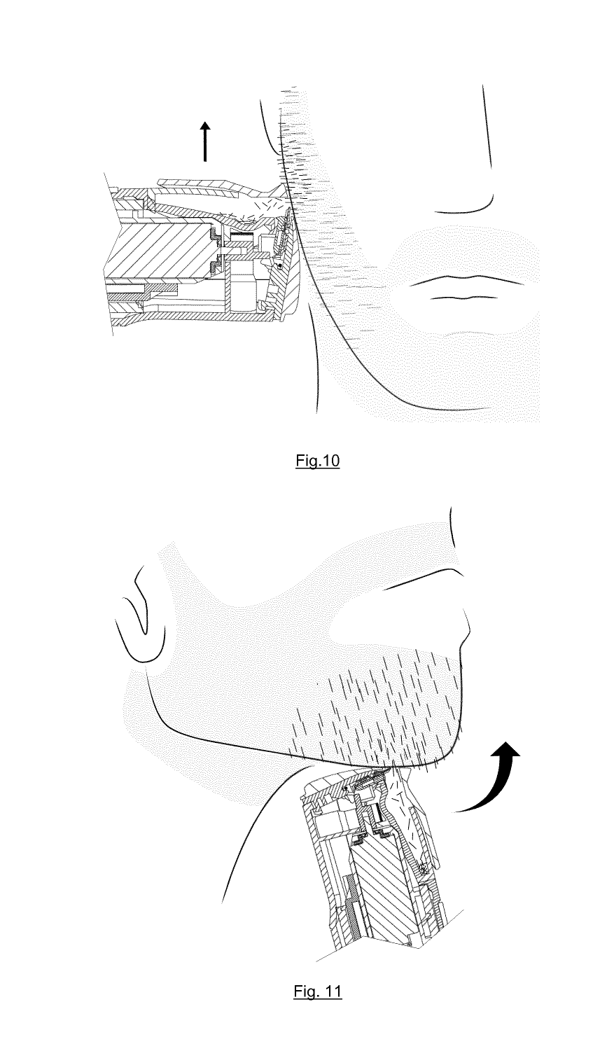

Still using the trimmer according to the invention from bottom to top, the hair collection is optimal. This approach is shown in FIGS. 10 and 11.

The dimensions of the hair collector 3 are only limited by the limitations of the design of the trimmer, i.e., the space available in the handle of a trimmer with ordinary dimensions, the aim always being to limit the overall bulk of the trimmer 1 and to allow the comb 4 to slide above the hair collector 3.

Since it is necessary to minimize the static electricity effect during trimming, the parts in contact with the hairs are made from a conductive material with a surface conductivity below 10⁶ Ohm, preferably below 10³ Ohm according to standard EN 13463-1. This makes it possible to prevent the hairs from “sticking” to the comb and ultimately clogging the travel toward the hair collector 3.

1. A suction-free trimmer (1) comprising a handle (2) with a built-in hair collector (3) located below the cutting system (6) which, in use, collects at least part of the cut hairs.

2. The trimmer according to claim 1, wherein the trimmer (1) is a beard trimmer.

3. The trimmer according to claim 1, wherein the hair collector (3) is made in the form of a cover (7) or in the form of a reservoir (8) fastened on the handle (2) in a hollow space having substantially the same shape as said cover (7) or reservoir (8).

4. The trimmer according to claim 1, wherein the hair collector (3) is removable.

5. The trimmer according to claim 1, further comprising a comb (4), the shape of the teeth (5) of which is configured so as to trap the hairs once they have passed through the comb (4) by gradually reducing the gap between the teeth (5) in the penetration direction.

6. The trimmer according to claim 1, wherein the teeth (5) have an inverted V shape.

7. The trimmer according to claim 1, wherein, in use, the comb (4) covers at least partly the hair collector (3).

8. The trimmer according to claim 1, wherein the comb (4) is removable to free the hair collector (3).

9. The trimmer according to claim 1, wherein the parts in contact with the hairs, in particular the comb (4), are made from a conductive material with a conductivity below 10³ Ohm.
